(19) United States
(12) Patent Application Publication
(10) Pub. No.: US 2025/0244117 A1
(43) Pub. Date: Jul. 31, 2025

(54) DOUBLE SIDED TAPE MEASURE DEVICE

(71) Applicant: Deanvaun Peynado, New Rochelle, NY (US)

(72) Inventor: Deanvaun Peynado, New Rochelle, NY (US)

(21) Appl. No.: 18/602,906

(22) Filed: Mar. 12, 2024

Related U.S. Application Data
(60) Provisional application No. 63/626,368, filed on Jan. 29, 2024.

(51) Int. Cl. G01B 3/1003; G01B 3/1046; G01B 3/1056

(52) U.S. Cl. CPC G01B 3/1003; G01B 3/1046; G01B 3/1056

(57) ABSTRACT

A double sided tape measure device for marking the location of an electrical fixture on a wall includes a tape measure that has a housing and a tape that is retractably contained in the housing. The tape is drawable outwardly from the housing to perform a measurement. The tape measure has a graduated scale applied to the tape thereby facilitating the graduated scale to measure distance. The tape measure has a fixture height scale applied to an opposing side of the tape with respect to the graduated scale. The fixture height scale is employed to measure the location height of various electrical fixtures from a floor to facilitate the worker to mark an installation spot of various electrical fixtures on a wall.

### (B) CROSS-REFERENCE TO RELATED APPLICATIONS

### Not Applicable

### (C) STATEMENT REGARDING FEDERALLY SPONSORED RESEARCH OR DEVELOPMENT

### Not Applicable

### (D) THE NAMES OF THE PARTIES TO A JOINT RESEARCH AGREEMENT

### Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

### Not Applicable

### (F) STATEMENT REGARDING PRIOR DISCLOSURES BY THE INVENTOR OR JOINT INVENTOR

### Not Applicable

### (G) BACKGROUND OF THE INVENTION

### (1) Field of the Invention

The disclosure relates to tape measure devices and more particularly pertains to a new tape measure device for marking the location of an electrical fixture on a wall. The device includes a tape measure that has a graduated scale applied to a top side of a tape of the tape measure for measuring distance. The device includes a fixture height scale applied to a bottom side of the tape for measuring the height of various electrical fixtures from a floor.

### (2) Description of Related Art Including Information Disclosed Under 37 CFR 1.97 and 1.98

The prior art relates to tape measure devices including a variety of measuring tape devices that have a graduated scale specifically designed for framing spacing in building construction and a variety of measuring tape devices which have a graduated scale and markings integrated into the graduated scale which indicate information pertaining to electrical fixtures. In no instance does the prior art disclose a tape measure that has a graduated scale on one side of a tape of the tape measure for measuring distance and a fixture height scale for measuring the height of an electrical fixture on a wall from a floor.

### (H) BRIEF SUMMARY OF THE INVENTION

An embodiment of the disclosure meets the needs presented above by generally comprising a tape measure that has a housing and a tape that is retractably contained in the housing. The tape is drawable outwardly from the housing to perform a measurement. The tape measure has a graduated scale applied to the tape thereby facilitating the graduated scale to measure distance. The tape measure has a fixture height scale applied to an opposing side of the tape with respect to the graduated scale. The fixture height scale is employed to measure the location height of various electrical fixtures from a floor to facilitate the worker to mark an installation spot of various electrical fixtures on a wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a double sided tape measure device according to an embodiment of the disclosure.

FIG. 2 is a bottom perspective view of an embodiment of the disclosure.

FIG. 3 is a right side phantom view of an embodiment of the disclosure.

FIG. 4 is a perspective in-use view of an embodiment of the disclosure.

### (J) DETAILED DESCRIPTION OF THE INVENTION

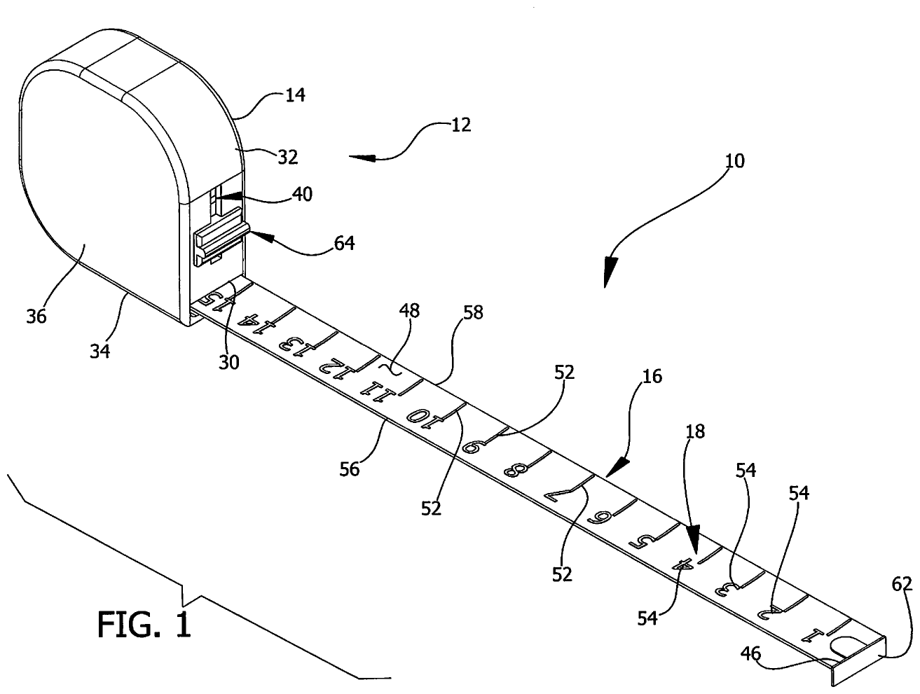

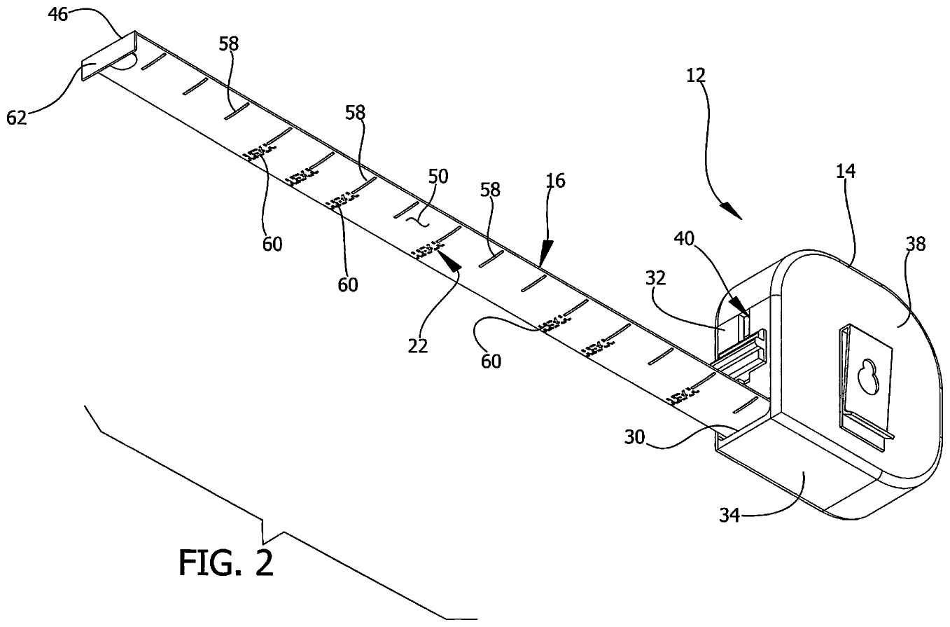

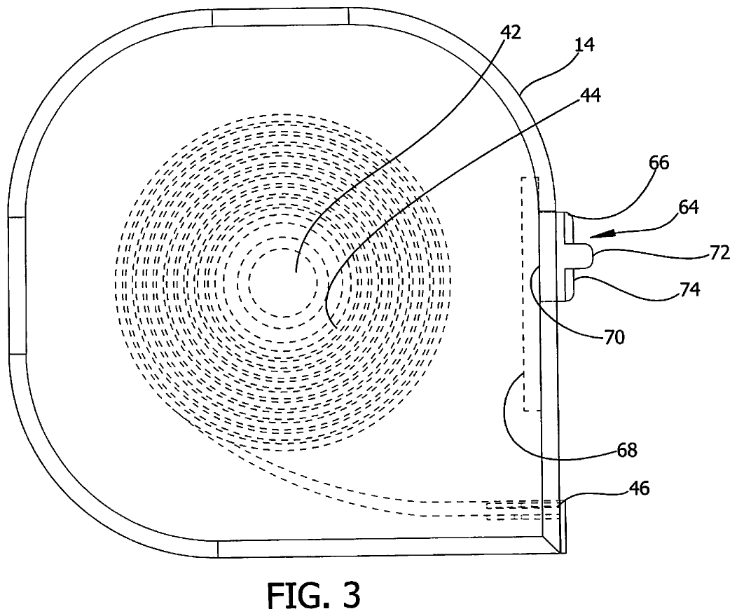

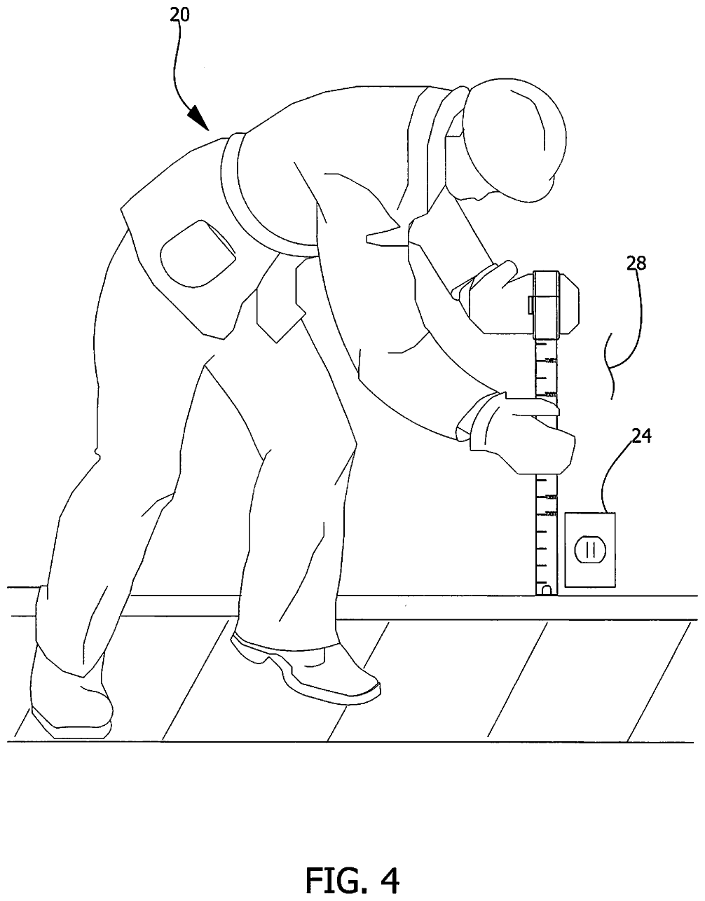

With reference now to the drawings, and in particular to FIGS. 1 through 4 thereof, a new tape measure device embodying the principles and concepts of an embodiment of the disclosure and generally designated by the reference numeral 10 will be described.

As best illustrated in FIGS. 1 through 4, the double sided tape measure device 10 generally comprises a tape measure 12 that has a housing 14 and a tape 16 which is retractably contained in the housing 14; the tape 16 is drawable outwardly from the housing 14 to perform a measurement. The tape measure 12 has a graduated scale 18 which is applied to the tape 16 thereby facilitating the graduated scale 18 to measure distance. In this way the tape measure 12 facilitates a worker 20 to measure the distance of a member to be cut, for example, or other distance that the worker 20 needs to measure. The tape measure 12 has a fixture height scale 22 which is applied to an opposing side of the tape 16 with respect to the graduated scale 18 thereby facilitating the fixture height scale 22 to measure the location height of various electrical fixtures 24 from a floor 26. In this way the tape measure 12 facilitates the worker 20 to mark an installation spot of various electrical fixtures 24 on a wall 28.

The housing 14 has a first slot 30 extending through a front side 32 of the housing 14 into an interior of the housing 14. The first slot 30 is positioned adjacent to a bottom side 34 of the housing 14 and the first slot 30 is oriented to extend between a first lateral side 36 and a second lateral side 38 of the housing 14. The housing 14 has a second slot 40 extending through the front side 32 of the housing 14 into the interior of the housing 14. The second slot 40 is vertically oriented on the front side 32 and the second slot 40 is spaced upwardly from the first slot 30.

The tape measure 12 includes a spool 42 that is rotatably disposed within the housing 14. The spool 42 is biased to rotate in a first direction and the spool 42 is urgeable to rotate in a second direction. The spool 42 extends between the first lateral side 36 and the second lateral side 38 of the housing 14 and the spool 42 is centrally located within the housing 14. The spool 42 may include a spring biasing member or other type of biasing member to bias the spool 42 to rotate in the first direction. The tape 16 has a coupled end 44 and a free end 46 and a top surface 48 and a bottom surface 50. The coupled end 44 is coupled to the spool 42 and the tape 16 is wrapped around the spool 42 when the spool 42 rotates in the first direction having the tape 16 extending outwardly from the first slot 30 in the front side 32 of the housing 14. Conversely, the spool 42 rotates in the second direction when the tape 16 is pulled outwardly from the first slot 30.

The graduated scale 18 is applied to the top surface 48 of the tape 16 and the graduated scale 18 comprises a plurality of first lines 52 and numerical indicia 54 that are aligned with respective ones of the plurality of first lines 52. The plurality of first lines 52 and the numerical indicia 54 are evenly spaced apart from each other and are distributed between the free end 46 and the coupled end 44 of the tape 16. Additionally, each of the plurality of first lines 52 extends from a first lateral edge 56 of the tape 16 toward a second lateral edge 57 of the tape 16. The numerical indicia 54 may include whole numbers and fractions to indicate inches or centimeters along the tape 16.

The fixture height scale 22 is applied to the bottom surface 50 of the tape 16 and the fixture height scale 22 comprises a plurality of second lines 58 and word indicia 60 which are aligned with respective ones of the plurality of second lines 58. The word indicia 60 comprise the names of various electrical fixtures 24 that are commonly installed in walls. Additionally, each of the names of various electrical fixtures 24 is aligned with respective ones of the plurality of second lines 58 thereby facilitating a height of each of the various electrical fixtures 24 to be measured from a floor 26. Furthermore, each of the plurality of second lines 58 extends from the first lateral edge 54 of the tape 16 toward the second lateral edge 56 of the tape 16. The various electrical fixtures 24 includes, but is not limited to, electrical outlets in a bedroom and electrical outlets in common areas and light switches and thermostats and other types of electrical fixtures 24 that are installed in residential or commercial construction. Furthermore, the height established for each of the various electrical fixtures 24 complies with the National Electrical Code and the Americans with Disabilities Act which dictates the installation of electrical fixtures 24 in the United States of America.

A grip 62 is coupled to and extends downwardly from the free end 46 of the tape 16 such that the grip 62 is perpendicularly oriented with the tape 16. In this way the grip 62 can be hooked on an object to facilitate performing a measurement. A lock 64 is slidably disposed on the housing 14 and the lock 64 comprises a panel 66 and a foot 68 extending away from a back side 70 of the panel 66 such that the foot 68 extends through the second slot 40. The panel 66 has a ridge 72 which extends laterally across a front side 74 of the panel 66 to enhance gripping the panel 66 for urging the lock 64 between a locked position and an unlocked position. The foot 68 is compressed against the tape 16 when the lock 64 is urged into the locked position thereby inhibiting the spool 42 from rotating in the first direction. Conversely, the foot 68 is displaced from the tape 16 when the lock 64 is urged into the unlocked position thereby facilitating the spool 42 to rotate in the first direction.

In use, the tape 16 is drawn out of the housing 14 and the graduated scale 18 is employed to measure distance in the conventional manner of employing a tape measure. The fixture height scale 22 is employed to measure the height that an electrical fixture 24 is to be positioned from a floor 26. In this way the worker 20 can quickly mark the location of a light switch, for example, and other electrical fixtures 24 that are to be installed during a construction project. Furthermore, the worker 20 can accurately mark the height of various electrical fixtures 24 in a manner that is in compliance with the National Electrical Code and the Americans with Disabilities Act while the worker 20 is performing rough in work for electrical fixtures during a construction project.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A double sided tape measure device for measuring distance and measuring the height of common electrical fixtures from a floor, said device comprising:
a tape measure having a housing and a tape being retractably contained in said housing, said tape being drawable outwardly from said housing to perform a measurement, said tape measure having a graduated scale being applied to said tape thereby facilitating said graduated scale to measure distance wherein said tape measure is configured to facilitate a worker to measure the distance of a member to be cut, said tape measure having a fixture height scale being applied to an opposing side of said tape with respect to said graduated scale thereby facilitating said fixture height scale to measure the location height of various electrical fixtures from a floor wherein said tape measure is configured to facilitate the worker to mark an installation spot of various electrical fixtures on a wall.

2. The device according to claim 1, wherein:
said housing has a first slot extending through a front side of said housing into an interior of said housing;
said first slot is positioned adjacent to a bottom side of said housing;
said first slot is oriented to extend between a first lateral side and a second lateral side of said housing;
said housing has a second slot extending through said front side of said housing into said interior of said housing;
said second slot is vertically oriented on said front side;
said second slot is spaced upwardly from said first slot;
said device includes a spool being rotatably disposed within said housing;
said spool is biased to rotate in a first direction;
said spool is urgeable to rotate in a second direction;
said spool extends between a first lateral side and a second lateral side of said housing;
said spool is centrally located within said housing;
said tape has a coupled end and a free end and a top surface and a bottom surface;
said coupled end is coupled to said spool;
said tape is wrapped around said spool when said spool rotates in said first direction having said tape extending outwardly from said first slot in said front side of said housing;
said spool rotates in said second direction when said tape is pulled outwardly from said first slot; and
said device includes a grip being coupled to and extending downwardly from said free end of said tape such that said grip is perpendicularly oriented with said tape wherein said grip is configured to be hooked on an object to facilitate performing a measurement.

3. The device according to claim 1, wherein:
said tape has a free end and a coupled end and a top surface and a bottom surface;
said graduated scale is applied to said top surface of said tape;
said graduated scale comprises a plurality of first lines and numerical indicia being aligned with respective ones of said plurality of first lines;
said plurality of first lines and said numerical indicia are evenly spaced apart from each other and are distributed between said free end and said coupled end of said tape; and
each of said plurality of first lines extends from said first lateral edge of said tape toward said second lateral edge of said tape.

4. The device according to claim 3, wherein:
said fixture height scale is applied to said bottom surface of said tape;
said fixture height scale comprises a plurality of second lines and word indicia being aligned with respective ones of said plurality of second lines;
said word indicia comprises the names of various electrical fixtures that are commonly installed in walls;
each of said names of various electrical fixtures being aligned with respective ones of said plurality of second lines thereby facilitating a height of each of said various electrical fixtures to be measured from a floor; and
each of said plurality of second lines extends from said first lateral edge of said tape toward said second lateral edge of said tape.

5. The device according to claim 2, wherein:
said device includes a lock being slidably disposed on said housing;
said lock comprises a panel and a foot extending away from a back side of said panel such that said foot extends through said second slot;
said panel has a ridge which extends laterally across a front side of said panel wherein said ridge is configured to enhance gripping said panel for urging said lock between a locked position and an unlocked position;
said foot is compressed against said tape when said lock is urged into said locked position thereby inhibiting said spool from rotating in said first direction; and
said foot is displaced from said tape when said lock is urged into said unlocked position thereby facilitating said spool to rotate in said first direction.

6. A double sided tape measure device for measuring distance and measuring the height of common electrical fixtures from a floor, said device comprising:
a tape measure having a housing and a tape being retractably contained in said housing, said tape being drawable outwardly from said housing to perform a measurement, said tape measure having a graduated scale being applied to said tape thereby facilitating said graduated scale to measure distance wherein said tape measure is configured to facilitate a worker to measure the distance of a member to be cut, said tape measure having a fixture height scale being applied to an opposing side of said tape with respect to said graduated scale thereby facilitating said fixture height scale to measure the location height of various electrical fixtures from a floor wherein said tape measure is configured to facilitate the worker to mark an installation spot of various electrical fixtures on a wall, said housing having a first slot extending through a front side of said housing into an interior of said housing, said first slot being positioned adjacent to a bottom side of said housing, said first slot being oriented to extend between a first lateral side and a second lateral side of said housing, said housing having a second slot extending through said front side of said housing into said interior of said housing, said second slot being vertically oriented on said front side, said second slot being spaced upwardly from said first slot;
wherein said device includes a spool being rotatably disposed within said housing, said spool being biased to rotate in a first direction, said spool being urgeable to rotate in a second direction, said spool extending between a first lateral side and a second lateral side of said housing, said spool being centrally located within said housing;
wherein said tape has a coupled end and a free end and a top surface and a bottom surface, said coupled end being coupled to said spool, said tape being wrapped around said spool when said spool rotates in said first direction having said tape extending outwardly from said first slot in said front side of said housing, said spool rotating in said second direction when said tape is pulled outwardly from said first slot;
wherein said graduated scale is applied to said top surface of said tape, said graduated scale comprising a plurality of first lines and numerical indicia being aligned with respective ones of said plurality of first lines, said plurality of first lines and said numerical indicia being evenly spaced apart from each other and being distributed between said free end and said coupled end of said tape, each of said plurality of first lines extending from a first lateral edge of said tape toward a second lateral edge of said tape;
wherein said fixture height scale is applied to said bottom surface of said tape, said fixture height scale comprising a plurality of second lines and word indicia being aligned with respective ones of said plurality of second lines, said word indicia comprising the names of various electrical fixtures that are commonly installed in walls, each of said names of various electrical fixtures being aligned with respective ones of said plurality of second lines thereby facilitating a height of each of said various electrical fixtures to be measured from a floor, each of said plurality of second lines extending from said first lateral edge of said tape toward said second lateral edge of said tape;
a grip being coupled to and extending downwardly from said free end of said tape such that said grip is perpendicularly oriented with said tape wherein said grip is configured to be hooked on an object to facilitate performing a measurement; and
a lock being slidably disposed on said housing, said lock comprising a panel and a foot extending away from a back side of said panel such that said foot extends through said second slot, said panel having a ridge which extends laterally across a front side of said panel wherein said ridge is configured to enhance gripping said panel for urging said lock between a locked position and an unlocked position, said foot being compressed against said tape when said lock is urged into said locked position thereby inhibiting said spool from rotating in said first direction, said foot being displaced from said tape when said lock is urged into said unlocked position thereby facilitating said spool to rotate in said first direction.
